(19) United States
(12) Patent Application Publication
(10) Pub. No.: US 2023/0068467 A1
(43) Pub. Date: Mar. 2, 2023

(54) MONITORING SYSTEM, MONITORING METHOD, AGENT PROGRAM AND MANAGER PROGRAM

(71) Applicant: Nippon Telegraph and Telephone Corporation, Tokyo (JP)

(72) Inventors: Masaru Sakai, Musashino-shi, Tokyo (JP); Kensuke TAKAHASHI, Musashino-shi, Tokyo (JP); Satoshi KONDO, Musashino-shi, Tokyo (JP)

(21) Appl. No.: 17/774,563

(22) PCT Filed: Nov. 12, 2019
(86) PCT No.: PCT/JP2019/044275

§ 371 Date: May 5, 2022

(51) Int. Cl. G06F 11/30

(52) U.S. Cl. CPC G06F 11/3048

(57) ABSTRACT

An agent device 1 of a monitoring system 5 includes: an acquisition unit 22 that sequentially acquires monitored values from a processing unit 21; a removal unit 23 that generates denoised monitored values by removing noise from the monitored values; and a transmission unit that transmits the denoised monitored values to a manager device 2. The manager device 2 includes a determination unit 62 that determines the monitoring interval, at which monitored values are acquired from the agent device 1, by referencing the denoised monitored values acquired from the agent device 1.

### TECHNICAL FIELD

The present invention relates to a monitoring system, a monitoring method, an agent program, and a manager program.

### BACKGROUND ART

In recent years, there has been a problem that the overhead for monitoring software components is increased along with complication of information provision services. Various costs in monitoring software components, such as resources such as data capacity and cost of communication with the components and setting of an optimum monitoring interval for each component by a maintenance person, have been increased.

In addition, the overhead for monitoring has been increased remarkably because of the spread of micro-service architectures.

There is a method of dynamically adjusting the monitoring interval in accordance with fluctuations in data, in order to reduce the overhead for monitoring (see NPL 1).

### CITATION LIST

### Non Patent Literature

[NPL 1] G. Tangari, D. Tuncer, M. Charalambides et al., “Self-Adaptive Decentralized Monitoring in Software-Defined Networks”, IEEE Transactions on Network and Service Management, 2018

### SUMMARY OF THE INVENTION

### Technical Problem

Monitored values acquired from an object to be monitored occasionally include noise, which is constant fluctuations in data, besides the essential monitored values. In that case, the monitored values acquired from the object to be monitored may be varied because of the noise, even if the essential monitored values are not varied significantly. If monitored data is acquired and the monitoring interval is determined by the method according to NPL 1 in such a state, the monitoring interval is set to be short, since the monitored values are varied along with generation of noise even if the essential monitored values are not varied. As a result, the overhead for monitoring may not be reduced appropriately.

The present invention has been made in view of the foregoing situation, and it is therefore an object of the present invention to provide a technique that enables a reduction in the overhead for monitoring even if monitored values include noise.

### Means for Solving the Problem

An aspect of the present invention provides a monitoring system including an agent device and a manager device connected to the agent device. The agent device includes an acquisition unit that sequentially acquires monitored values from a processing unit, a removal unit that generates denoised monitored values by removing noise from the monitored values, and a transmission unit that transmits the denoised monitored values to the manager device. The manager device includes a determination unit that determines a monitoring interval, at which the monitored values are acquired from the agent device, by referencing the denoised monitored values acquired from the agent device.

An aspect of the present invention provides a monitoring method including: an agent device sequentially acquiring monitored values from a processing unit; the agent device generating denoised monitored values by removing noise from the monitored values; the agent device transmitting the denoised monitored values to a manager device; and the manager device determining a monitoring interval, at which the monitored values are acquired from the agent device, by referencing the denoised monitored values acquired from the agent device.

An aspect of the present invention provides an agent program that causes a computer to function as the agent device described above.

An aspect of the present invention provides a manager program that causes a computer to function as the manager device described above.

### Effects of the Invention

With the present invention, it is possible to provide a technique that enables a reduction in the overhead for monitoring even if monitored values include noise.

### BRIEF DESCRIPTION OF DRAWINGS

FIG. 1 illustrates the system configuration of a monitoring system according to an embodiment of the present invention.

FIG. 2 illustrates functional blocks of an agent device.

FIG. 3 illustrates an example of denoised monitored values output from the agent device.

FIG. 4 illustrates functional blocks of a manager device.

FIG. 5 illustrates an example in which the manager device changes the monitoring interval on the basis of the denoised monitored values.

FIG. 6 illustrates a process in which the manager device changes the monitoring interval on the basis of the denoised monitored values (part 1).

FIG. 7 illustrates a process in which the manager device changes the monitoring interval on the basis of the denoised monitored values (part 2).

FIG. 8 is a sequence diagram illustrating an example of a process in which the agent device transmits the denoised monitored values to the manager device in the monitoring system.

FIG. 9 is a sequence diagram illustrating an example of a process in which the agent device transmits monitored values to the manager device in the monitoring system.

FIG. 10 illustrates the hardware configuration of a computer for use as the agent device or the manager device.

### DESCRIPTION OF EMBODIMENTS

An embodiment of the present invention will be described below with reference to the drawings. In the description of the drawings, like components are denoted by like numerals to omit description.

(Monitoring System)

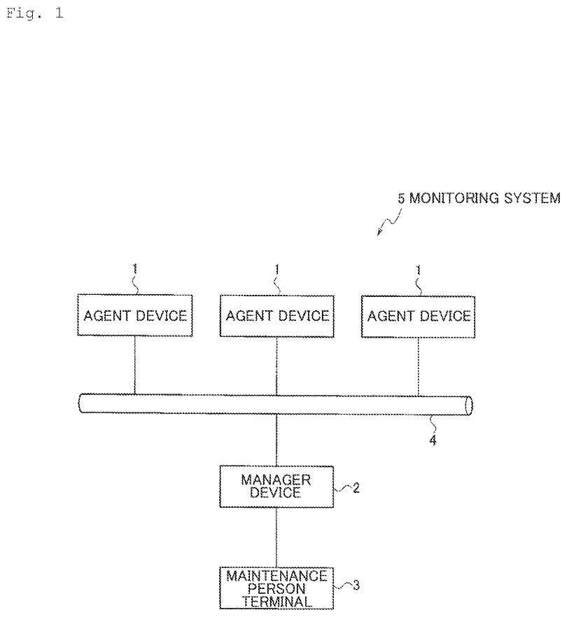

A monitoring system 5 according to the embodiment of the present invention will be described with reference to FIG. 1. The monitoring system 5 includes a plurality of agent devices 1, a manager device 2, and a maintenance person terminal 3.

In the embodiment of the present invention, one manager device 2 is provided for the plurality of agent devices 1. However, the present invention is not limited thereto. For example, a plurality of manager devices 2 may be provided for the plurality of agent devices 1. The monitoring system 5 may include a plurality of maintenance person terminals 3.

The plurality of agent devices 1 and the manager device 2 are communicably connected to each other via a communication network 4. The communication network 4 may be a private network such as a LAN (Local Area Network), or may be a public network such as the Internet.

The manager device 2 and the maintenance person terminal 3 are connected to each other by any method. The maintenance person terminal 3 and the manager device 2 may be connected to each other through a private network or a public network as with the communication network 4, or may be connected to each other in a P2P (peer-to-peer) manner.

The agent device 1 transmits values monitored by a processing unit such as a software component to the manager device 2. The agent device 1 transmits monitored values after being subjected to noise removal in some cases, and transmits monitored values before being subjected to noise removal in other cases, in response to a request from the manager device 2.

The manager device 2 requests monitored values after being subjected to noise removal, or monitored values before being subjected to noise removal, from the agent device 1. The monitored values after being subjected to noise removal are used by the manager device 2 to determine the interval at which monitored values before being subjected to noise removal are requested. The monitored values before being subjected to noise removal are presented to a maintenance person via the maintenance person terminal 3.

The maintenance person terminal 3 presents, to the maintenance person, the monitored value before being subjected to noise removal provided from the manager device 2. In the embodiment of the present invention, the manager device 2 and the maintenance person terminal 3 are individual computers. However, the present invention is not limited thereto. The monitoring system 5 may not include the maintenance person terminal 3, and the maintenance person may confirm the monitored values before being subjected to noise removal on a display device (not illustrated) connected to the manager device 2, for example.

(Agent Device)

The agent device 1 acquires values monitored by a processing unit 21, and transmits monitored values before being subjected to noise removal and monitored values after being subjected to noise removal to the manager device 2.

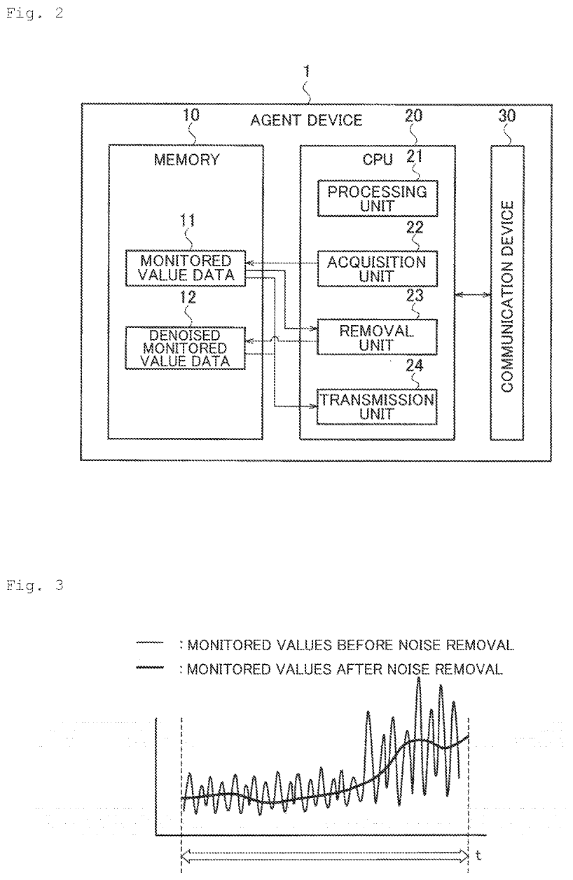

As illustrated in FIG. 2, the agent device 1 includes a memory 10, a CPU 20, and a communication device 30. The agent device 1 is a common computer. An agent program allows the agent device 1 to implement the functions illustrated in FIG. 2. The communication device 30 is an interface for communication with other devices.

In the embodiment of the present invention, the agent device 1 is implemented on a computer that includes a processing unit that processes software components. However, the present invention is not limited thereto. For example, the agent device 1 may be implemented on a computer that is different from the processing unit which processes software components. In addition, the computer may be a physical computer, or may be a virtual computer.

The memory 10 stores the agent program, and stores monitored value data 11 and denoised monitored value data 12.

The monitored value data 11 is data on monitored values acquired from the processing unit 21. The monitored value data 11 includes a plurality of data sets in which the time when a monitored value is acquired, the type of the monitored value, the monitored value, etc. are correlated, for example. The type of the monitored value may be an identifier that distinguishes the amount of network traffic to be input to or output from the processing unit 21, the CPU use rate of the processing unit 21, the memory use amount, etc., for example.

The denoised monitored value data 12 is data on denoised monitored values obtained by removing noise from monitored values. The denoised monitored value data 12 includes a plurality of data sets in which the time when a monitored value to be subjected to noise removal is acquired, the type of the monitored value, the denoised monitored value, etc. are correlated, for example. The denoised monitored value data 12 indicates essential variations in monitored values.

The monitored value data 11 may include monitored values for a period, monitored values for which are possibly requested by the manager device 2. Monitored values for a period, monitored values for which are not possibly requested by the manager device 2, may be deleted from the monitored value data 11. Similarly, the denoised monitored value data 12 may include denoised monitored values for a period, denoised monitored values for which are possibly requested by the manager device 2. Denoised monitored values for a period, denoised monitored values for which are not possibly requested by the manager device 2, may be deleted from the denoised monitored value data 12.

The CPU 20 includes a processing unit 21, an acquisition unit 22, a removal unit 23, and a transmission unit 24.

The processing unit 21 executes a process for providing a service to a user. The processing unit 21 may be a software component etc., for example, and is monitored by the manager device 2.

The acquisition unit 22 sequentially acquires monitored values from the processing unit 21. The acquisition unit 22 sequentially acquires monitored values such as the amount of network traffic to be input to or output from the processing unit 21, the CPU use rate of the processing unit 21, the memory use amount, etc., and stores the monitored values in the monitored value data 11.

The monitored values acquired by the acquisition unit 22 occasionally contain noise. The noise may, or may not, be associated with the process by the processing unit 21, and the cause of the noise may not be specified.

The removal unit 23 generates denoised monitored values by removing noise from the monitored values. The removal unit 23 generates denoised monitored value data 12 by correlating the denoised monitored value, which is obtained by removing noise from each monitored value in the monitored value data 11, and the time, the type of the monitored value, etc.

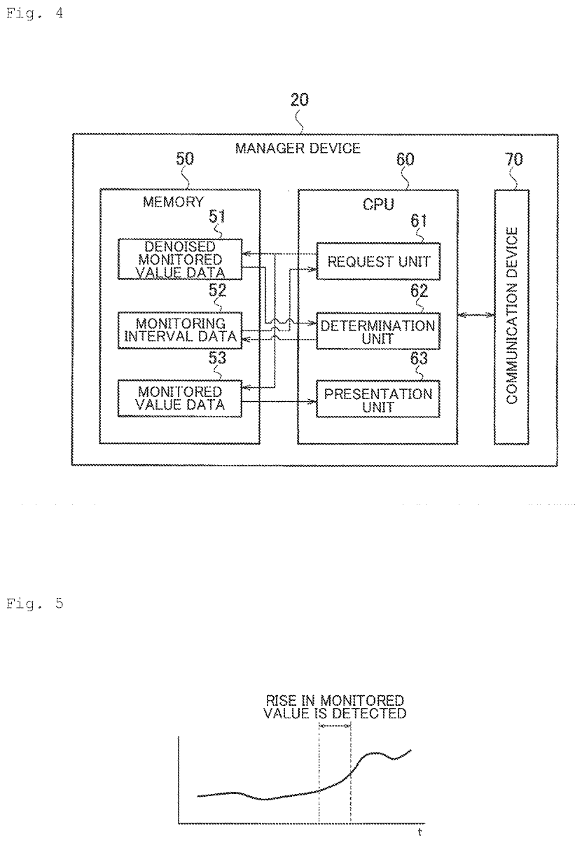

The removal unit 23 generates denoised monitored values from monitored values for a predetermined period including the time for processing, by removing noise from monitored values at the time for processing. FIG. 3 illustrates an example of monitored values before being subjected to noise removal and monitored values after being subjected to noise removal for a predetermined period. A monitored value before being subjected to noise removal for the rightmost monitored value in FIG. 3 is calculated from monitored values for the predetermined period in FIG. 3. In this manner, a monitored value before being subjected to noise removal are calculated for each monitored value by referencing previous monitored values.

Several methods are conceivable for the removal unit 23 to remove noise from monitored values. For example, the removal unit 23 may generate denoised monitored values on the basis of a moving average of monitored values for a predetermined period. Alternatively, the removal unit 23 may generate denoised monitored values on the basis of a discrete Fourier transform of monitored values for a predetermined period.

The transmission unit 24 transmits the denoised monitored values in the denoised monitored value data 12 to the manager device 2. The transmission unit 24 may also transmit the monitored values in the monitored value data 11 to the manager device 2.

The transmission unit 24 transmits the denoised monitored values or the monitored values to the manager device 2 in accordance with a request from the manager device 2. The transmission unit 24 may transmit the denoised monitored values or the monitored values to the manager device 2 voluntarily in accordance with a predetermined logic.

(Manager Device) The manager device 2 requests monitored values after being subjected to noise removal, or monitored values before being subjected to noise removal, from the agent device 1, and processes the acquired data or presents such data to the maintenance person terminal 3.

As illustrated in FIG. 4, the manager device 2 includes a memory 50, a CPU 60, and a communication device 70. The manager device 2 is a common computer. A manager program allows the manager device 2 to implement the functions illustrated in FIG. 4. The communication device 70 is an interface for communication with other devices.

The memory 50 stores the manager program, and stores denoised monitored value data 51, monitoring interval data 52, and monitored value data 53.

The denoised monitored value data 51 is data on denoised monitored values transmitted from the agent device 1. Similarly, the monitored value data 53 is data on monitored values transmitted from the agent device 1. The denoised monitored value data 51 and the monitored value data 53 have the same data structure as the respective data possessed by the agent device 1.

The monitoring interval data 52 is data including the monitoring interval determined by a determination unit 62 to be discussed later. The manager device 2 requests monitored values from the agent device 1 at the monitoring intervals set in the monitoring interval data 52.

The CPU 60 includes a request unit 61, a determination unit 62, and a presentation unit 63.

The request unit 61 requests denoised monitored values, from which noise has been removed, from the agent device 1. The request unit 61 includes the denoised monitored values, which have been acquired through the request, in the denoised monitored value data 51. The request unit 61 also requests monitored values from the agent device 1 at the monitoring intervals determined by the determination unit 62. The request unit 61 includes the monitored values, which have been acquired through the request, in the monitored value data 53.

The determination unit 62 determines the monitoring interval, at which monitored values are acquired from the agent device 1, by referencing the denoised monitored values acquired from the agent device 1. In the embodiment of the present invention, when a plurality of types of monitored values are handled, the monitoring interval for the type is determined for each type from denoised monitored values for the type.

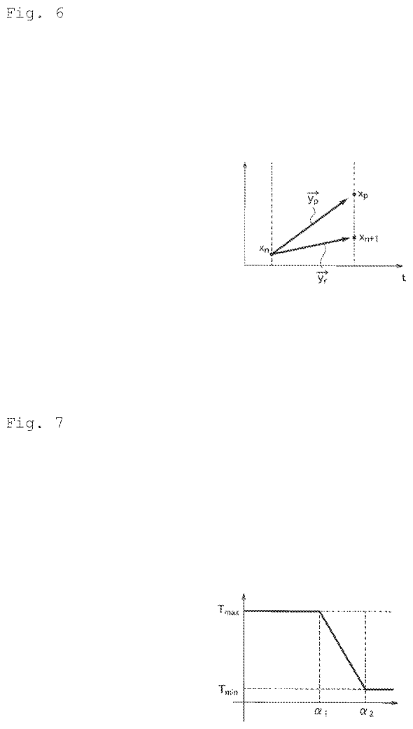

For example, it is assumed that denoised monitored values for a certain type in the denoised monitored value data 51 transition as indicated in FIG. 5. The determination unit 62 detects a rise in monitored values for a section indicated by the arrow in FIG. 5. At this timing, the determination unit 62 updates the monitoring interval, at which monitored values are acquired.

The presentation unit 63 presents the monitored values acquired by the request unit 61 to the maintenance person terminal 3. The method for the presentation unit 63 to present monitored values is not limited thereto. For example, monitored values may be presented to the maintenance person in a mail, a message, etc.

(Noise Removal Method)

A noise removal method that is used by the removal unit 23 of the agent device 1 will be described.

First, a noise removal method based on a moving average will be described. Here, a method of removing noise from xₙ, namely a data row of monitored values x₀, x₁, x₂, . . . , xₙ₋₁, and xₙ, will be described. A denoised monitored value yₙ obtained by removing noise from a monitored value xₙ is represented by the formula (1).

$$\begin{matrix}[ Math . 1 ] & \\ {y}_{n} = \frac{{x}_{n} + {x}_{n - 1} + … + {x}_{n - N + 1}}{N} & Formula ( 1 )\end{matrix}$$

The denoised monitored value yₙ is a moving average for a predetermined window size N. The denoised monitored value yₙ transitions smoothly.

Next, a noise removal method based on a Fourier transform will be described. Here, a method of removing noise from a data row of monitored values x₀, x₁, x₂, . . . , and x_{N-1}, will be described. A discrete Fourier transform for a window size N is represented by the formula (2), and an inverse transform is represented by the formula (3).

$$\begin{matrix}[ Math . 2 ] & \\ \begin{matrix}X ( k ) = {\sum }_{i = 0}^{N - 1} {x}_{i} exp ( \frac{- j 2 π ki}{N} ) & ( 0 \leq k \leq N - 1 )\end{matrix} & Formula ( 2 )\end{matrix}$$

$$\begin{matrix}[ Math . 3 ] & \\ \begin{matrix}{x}_{i} = \frac{1}{N} {\sum }_{k = 0}^{N - 1} X ( k ) exp ( \frac{j 2 π ki}{N} ) & ( 0 \leq i \leq N - 1 )\end{matrix} & Formula ( 3 )\end{matrix}$$

To remove frequency components that are more than a certain frequency a, a discrete Fourier transform is performed using the formula (2). After performing a discrete Fourier transform, an inverse transform is performed by substituting X(k), which is obtained by processing X(k)=0 (a≤k), into the formula (3). Consequently, denoised monitored values x₀, x₁, x₂, . . . , and x_{N-1}, from which noise has been removed, are obtained.

While a method based on a moving average and a method based on a Fourier transform are described as the noise removal method herein, the present invention is not limited thereto. The removal unit 23 may remove noise from monitored values by any method.

(Method of Determining Monitoring Interval)

A method by which the determination unit 62 of the manager device 2 determines the monitoring interval will be described. The determination unit 62 changes the monitoring interval in accordance with the similarity between a predicted value estimated from previous denoised monitored values and the denoised monitored values acquired from the agent device 1. The determination unit 62 calculates the similarity between a predicted value estimated from previous denoised monitored values and the denoised monitored values acquired from the agent device 1, for example. The determination unit 62 changes the monitoring interval to be shorter when the similarity is less than a first threshold, and changes the monitoring interval to be longer when the similarity is more than a second threshold.

First, the determination unit 62 calculates a predicted value xₚ at time ₙ₊₁ for a data row x₀, x₁, x₂, . . . , and xₙ and time stamps t₀, t₁, t₂, . . . , and tₙ for the data points using the formula (4).

$$\begin{matrix}[ Math . 4 ] & \\ {x}_{p} = {x}_{n} + \frac{{t}_{n + 1} - {t}_{n}}{N - 1} {\sum }_{i = n - N + 1}^{n - 1} \frac{{x}_{i + 1} - {x}_{i}}{{t}_{i + 1} - {t}_{i}} & Formula ( 4 )\end{matrix}$$

$$N : Window size$$

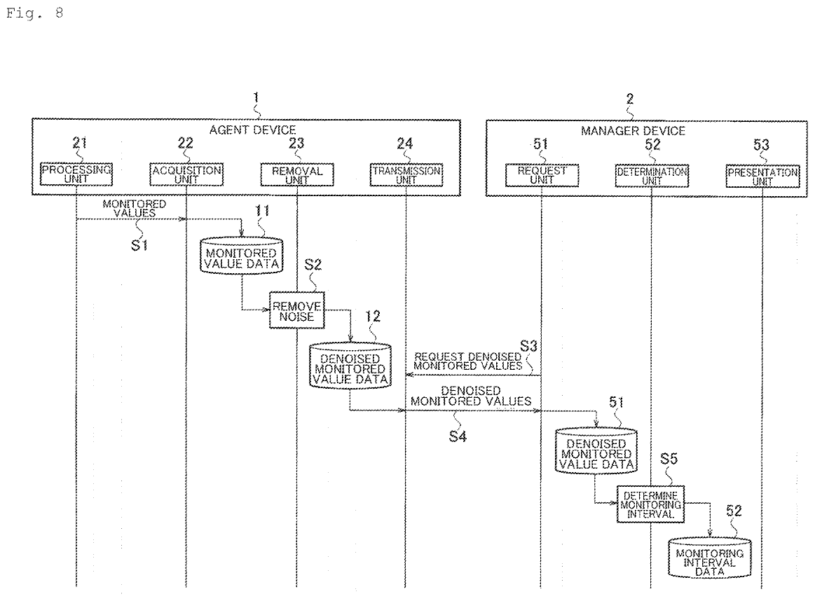

A value measured at time ₙ₊₁ is defined as xₙ₊₁. A predicted vector and a measured vector are defined as indicated in FIG. 6.

A similarity vector for the predicted vector and the measured vector is calculated using the formula (5).

$$\begin{matrix}[ Math . 5 ] & \\ S ( \vec{{y}_{p}} , \vec{{y}_{r}} ) = \frac{( \vec{{y}_{p}} , \vec{{y}_{r}} )}{‖ \vec{{y}_{p}} ‖ \cdot ‖ \vec{{y}_{r}} ‖} & Formula ( 5 )\end{matrix}$$

$$Similarity vector : S ( \vec{{y}_{p}} , \vec{{y}_{r}} )$$

$$Predicted vector : \vec{{y}_{p}}$$

$$Measured vector : \vec{{y}_{r}}$$

A variation score α(xₙ₊₁) for data xₙ₊₁ at time ₙ₊₁ is calculated using the formula (6).

[Math. 6]

if S(\vec{yₚ},\vec{yᵣ})≥0:

a(xₙ₊₁)=1−(\vec{yₚ},\vec{yᵣ})

else

a(xₙ₊₁)=1 Formula (6)

The determination unit 62 estimates a parameter of a probability density function on the assumption that a set of variations scores for data points x_{n-N+1}, . . . , and xₙ are normally distributed. The determination unit 62 takes two points in the probability distribution, namely a point at α₁% and a point at α₂%. The determination unit 62 determines an interval T_{new} before the next data point using the formula (7). The relationship among Tₘₐₓ, Tₘᵢₙ, α₁, and α₂ is indicated in FIG. 7.

$$\begin{matrix}[ Math . 7 ] & \\ if α ( {x}_{n + 1} ) \geq {α}_{1} : {T}_{new} := {T}_{max} & Formula ( 7 )\end{matrix}$$

$$if {α}_{1} \leq α ( {x}_{n + 1} ) \leq {α}_{2} : {T}_{new} := \frac{{T}_{max} - {T}_{min}}{{α}_{1} - {α}_{2}} ( α ( x ) - {α}_{1} ) + {T}_{max}$$

$$if α ( {x}_{n + 1} ) \leq {α}_{2} : {T}_{new} := {T}_{min}$$

The determination unit 62 outputs the interval T_{new} calculated using the formula (7) as the monitoring interval.

(Monitoring Method)

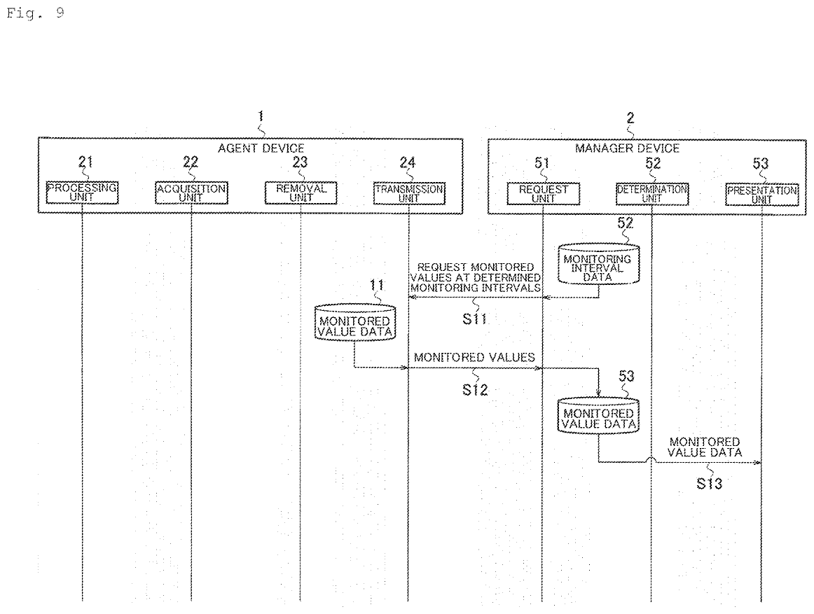

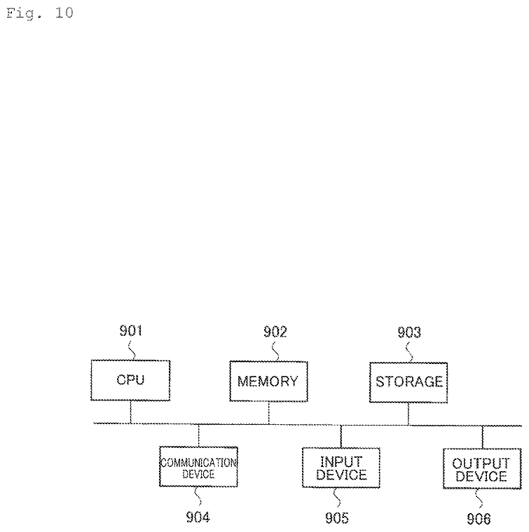

A monitoring method that is used by the monitoring system 5 will be described with reference to FIGS. 8 and 9.

The processing unit 21 of the agent device 1 performs processing. In step S1, the acquisition unit 22 acquires monitored values from the processing unit 21. The acquisition unit 22 may acquire monitored values from a component other than the processing unit 21, depending on the type of the monitored values. The acquisition unit 22 stores the acquired monitored values in the monitored value data 11.

In step S2, the removal unit 23 removes noise from the monitored values stored in the monitored value data 11, and stores denoised monitored values in the denoised monitored value data 12.

In step S3, the request unit 61 of the manager device 2 requests denoised monitored values. When there is a request for denoised monitored values, the transmission unit 24 of the agent device 1 acquires the denoised monitored values stored in the denoised monitored value data 12, and transmits the acquired denoised monitored values to the manager device 2 in step S4. The request unit 61 of the manager device 2 stores the denoised monitored values acquired from the agent device 1 in the denoised monitored value data 51.

In step S5, the determination unit 62 determines the monitoring interval, at which monitored values are requested, by referencing the denoised monitored value data 51. The determined monitoring interval is stored in the monitoring interval data 52.

In step S11, the request unit 61 of the manager device 2 requests monitored values from the agent device 1 at the monitoring intervals stored in the monitoring interval data 52. When there is a request for monitored values, the transmission unit 24 of the agent device 1 acquires the monitored values stored in the monitored value data 11, and transmits the acquired monitored values to the manager device 2 in step S12. The request unit 61 of the manager device 2 stores the monitored values acquired from the agent device 1 in the monitored value data 53.

In step S13, the presentation unit 63 acquires the monitored values from the monitored value data 53, and outputs the acquired monitored values to the maintenance person terminal 3, etc.

In the monitoring system 5 according to the embodiment of the present invention, the manager device 2 can determine the monitoring interval, at which monitored values are acquired, by referencing denoised monitored values which are acquired from the agent device 1 and from which noise has been removed. The manager device 2 can determine the monitoring interval on the basis of essential fluctuations in the monitored values, without being affected by the presence or absence of noise, by referencing the denoised monitored values, from which noise has been removed.

A general-purpose computer system such as that illustrated in FIG. 10, for example, is used for each of the agent device 1 and the manager device 2 according to the present embodiment described above. The general-purpose computer includes a CPU (Central Processing Unit, processor) 901, a memory 902, a storage 903 (HDD: Hard Disk Drive, SSD: Solid State Drive), a communication device 904, an input device 905, and an output device 906.

The CPU 901 corresponds to each of the CPU 20 of the agent device 1 and the CPU 60 of the manager device 2. The memory 902 corresponds to each of the memory 10 of the agent device 1 and the memory 50 of the manager device 2. Data stored in the agent device 1 and the manager device 2 may be stored in the storage 903. The communication device 904 corresponds to each of the communication device 30 of the agent device 1 and the communication device 70 of the manager device 2.

In the computer system, the functions of the agent device 1 are implemented by the CPU 901 executing an agent program loaded onto the memory 902. In the computer system, similarly, the functions of the manager device 2 are implemented by the CPU 901 executing a manager program loaded onto the memory 902.

The agent device 1 and the manager device 2 may each be implemented by a single computer, or may each be implemented by a plurality of computers. The agent device 1 and the manager device 2 may each be a virtual machine implemented on a computer.

The programs for the agent device 1 and the manager device 2 may be stored in a computer-readable storage medium such as an HDD, an SSD, a USB (Universal Serial Bus) memory, a CD (Compact Disc), or a DVD (Digital Versatile Disc), or may be distributed via a network.

The present invention is not limited to the embodiment described above, and may be modified variously within the scope and spirit of the present invention.

### REFERENCE SIGNS LIST

1 Agent device
2 Manager device
3 Maintenance person terminal
4 Communication network
Monitoring system
10, 50, 902 Memory
11, 53 Monitored value data
12, 51 Denoised monitored value data
20, 60, 901 CPU
21 Processing unit
22 Acquisition unit
23 Removal unit
24 Transmission unit
30, 70, 904 Communication device
52 Monitoring interval data
61 Request unit
62 Determination unit
63 Presentation unit
903 Storage
905 Input device
906 Output device

1. A monitoring system comprising
an agent device and a manager device connected to the agent device, wherein
the agent device includes one or more processors configured to:
sequentially acquire monitored values from a processing unit,
generate denoised monitored values by removing noise from the monitored values, and
transmit the denoised monitored values to the manager device, and
the manager device includes one or more processors configured to
determine a monitoring interval, at which the monitored values are acquired from the agent device, by referencing the denoised monitored values acquired from the agent device.

2. The monitoring system according to claim 1, wherein
the manager device includes one or more processors configured to
request the monitored values from the agent device at determined monitoring intervals.

3. The monitoring system according to claim 1, wherein
the agent device includes one or more processors configured to generate the denoised monitored values on the basis of a moving average of monitored values for a predetermined period.

4. The monitoring system according to claim 1, wherein
the agent device includes one or more processors configured to generate the denoised monitored values on the basis of a discrete Fourier transform of monitored values for a predetermined period.

5. The monitoring system according to claim 1, wherein
the manager device includes one or more processors configured to change the monitoring interval in accordance with a similarity between a predicted value estimated from previous denoised monitored values and the denoised monitored values acquired from the agent device.

6. A monitoring method comprising:
sequentially acquiring, by an agent device, monitored values from a processing unit;
generating, by the agent device, denoised monitored values by removing noise from the monitored values;
transmitting, by the agent device, the denoised monitored values to a manager device; and
determining, by the manager device, a monitoring interval, at which the monitored values are acquired from the agent device, by referencing the denoised monitored values acquired from the agent device.

7. A non-transitory computer readable medium storing one or more instructions causing a computer to function as an agent device that executes:
sequentially acquiring monitored values from a processing unit;
generating denoised monitored values by removing noise from the monitored values; and
transmitting the denoised monitored values to a manager device.

8. (canceled)

9. The monitoring method according to claim 6, further comprising:
requesting, by the manager device, the monitored values from the agent device at determined monitoring intervals.

10. The monitoring method according to claim 6, further comprising:
generating, by the agent device, the denoised monitored values on the basis of a moving average of monitored values for a predetermined period.

11. The monitoring method according to claim 6, further comprising:
generating, by the agent device, the denoised monitored values on the basis of a discrete Fourier transform of monitored values for a predetermined period.

12. The monitoring method according to claim 6, further comprising:
changing, by the manager device, the monitoring interval in accordance with a similarity between a predicted value estimated from previous denoised monitored values and the denoised monitored values acquired from the agent device.

13. The non-transitory computer readable medium according to claim 7, wherein:
the manager device determines a monitoring interval, at which the monitored values are acquired from the agent device, by referencing the denoised monitored values acquired from the agent device, and
the manager device requests the monitored values from the agent device at determined monitoring intervals.

14. The non-transitory computer readable medium according to claim 13, wherein
the manager device changes the monitoring interval in accordance with a similarity between a predicted value estimated from previous denoised monitored values and the denoised monitored values acquired from the agent device.

15. The non-transitory computer readable medium according to claim 7, wherein one or more instructions further cause the computer to execute:
generating the denoised monitored values on the basis of a moving average of monitored values for a predetermined period.

16. The non-transitory computer readable medium according to claim 7, wherein one or more instructions further cause the computer to execute:
generating the denoised monitored values on the basis of a discrete Fourier transform of monitored values for a predetermined period.
